(19) United States
(12) Patent Application Publication
(10) Pub. No.: US 2019/0315195 A1
(43) Pub. Date: Oct. 17, 2019

(54) HVAC/R SYSTEM FOR A VEHICLE CARGO COMPARTMENT AND METHOD OF OPERATING AN HVAC/R SYSTEM FOR A VEHICLE CARGO COMPARTMENT

(71) Applicant: Carrier Corporation, Palm Beach Gardens, FL (US)

(72) Inventor: Michael Swab, Acworth, GA (US)

(21) Appl. No.: 16/462,331

(22) PCT Filed: Nov. 21, 2017
(86) PCT No.: PCT/US17/62839

§ 371 Date: May 20, 2019

Related U.S. Application Data
(60) Provisional application No. 62/424,884, filed on Nov. 21, 2016.

(51) Int. Cl. B60H 1/03; F25D 11/00; F25D 21/12; B60H 1/32; B60H 1/00; B60H 1/02

(52) U.S. Cl. CPC B60H 1/03; F25D 11/003; B60H 1/02; B60H 1/3232; B60H 1/00014; F25D 21/12

(57) ABSTRACT

An HVAC/R system (10) for a vehicle cargo compartment (12) is provided. The HVAC/R system (10) includes an external heat exchanger (26) disposed outside of the vehicle cargo compartment (12) and configured to transfer heat from ambient air to a fluid (32), an internal heat exchanger (24) disposed inside of the vehicle cargo compartment (12) and configured to transfer heat from the fluid (32) to the vehicle cargo compartment (12), and a fluid circuit (30) configured to selectively circulate the fluid (32) between the external heat exchanger (26) and the internal heat exchanger (24) and a second fluid circuit (40) configured to selectively circulate the fluid (32) between the external heat exchanger (26) and an engine (18).

### CROSS-REFERENCE TO RELATED APPLICATION

The present application is an international patent application, which claims the priority benefit of U.S. Application Ser. No. 62/424,884, filed Nov. 21, 2016, the text and drawings of which are hereby incorporated in its entirety.

### TECHNICAL FIELD OF THE DISCLOSED EMBODIMENTS

The presently disclosed embodiments generally relate to heating, ventilation, air conditioning, and refrigeration (HVAC/R) systems, and more particularly, to a system and method of operating an HVAC/R system for a vehicle cargo compartment.

### BACKGROUND OF THE DISCLOSED EMBODIMENTS

Trucks and other vehicles often transport goods that require a refrigerated or otherwise temperature-controlled cargo compartment. Such vehicles often include a transport refrigeration unit (TRU) that operates to maintain a set point temperature of the cargo compartment. Such TRUs include one or more controllers, compressors, condensers, control valves, expansion valves, evaporator coils, and/or other components typically found in an HVAC/R unit to maintain one or more set point temperatures.

The TRU may be powered in a normal cooling mode to circulate refrigerant to the relatively cool evaporator in the vehicle cargo compartment in order to cool the air in the vehicle cargo compartment and maintain a low set point temperature of the system. However, frost can accumulate on the evaporator in the vehicle cargo compartment and/or the temperature of the vehicle cargo compartment may drop below the set point of the system. Therefore, the system must operate in a heating mode. In conventional systems, an engine, such as the TRU engine, is started and run to generate and supply heat to the coolant circuit for circulation to a heat exchanger in the vehicle cargo unit to raise the temperature to reach the set point or to defrost the evaporator. However, starting and running the engine whenever even a small amount of heat is required leads to excess fuel consumption, unnecessary wear on the engine and other components, and air and noise pollution.

Therefore, there exists a need for an HVAC/R system for a vehicle cargo compartment and method of operating an HVAC/R system for a vehicle cargo compartment that more efficiently raises the air temperature in the vehicle cargo compartment.

### SUMMARY OF THE DISCLOSED EMBODIMENTS

In accordance with an embodiment of the present disclosure, an HVAC/R system for a vehicle cargo compartment is provided. The HVAC/R system includes an external heat exchanger disposed outside of the vehicle cargo compartment and configured to transfer heat from ambient air to a fluid, an internal heat exchanger disposed inside of the vehicle cargo compartment and configured to transfer heat from the fluid to the vehicle cargo compartment; and a fluid circuit configured to selectively circulate the fluid between the external heat exchanger and the internal heat exchanger.

The external heat exchanger may be configured to transfer heat from ram air to the fluid when the vehicle cargo compartment is moving. The external heat exchanger may be configured to transfer heat from ambient air to the fluid when the vehicle cargo compartment is stationary. The system may further include an evaporator heat exchanger and an evaporator fan disposed inside of the vehicle cargo compartment, the internal heat exchanger may transfer heat from the fluid to the vehicle cargo compartment with the evaporator fan. The fluid circuit may include a pump configured to selectively circulate the fluid. The pump may be configured to be operated under battery power. The system may further include a second fluid circuit configured to selectively circulate the fluid between the external heat exchanger and an engine, the engine may transfer heat to the fluid. The second fluid circuit may be configured to circulate the fluid between the external heat exchanger and the engine when the ambient air is below a predetermined temperature. The fluid circuit may be in fluid communication with the second fluid circuit when the ambient air is below the predetermined temperature.

In accordance with an embodiment of the present disclosure, a method of operating an HVAC/R system in a vehicle cargo compartment is provided. The method includes circulating a fluid between an internal heat exchanger and an external heat exchanger, transferring heat from ambient air to the fluid in the external heat exchanger when the ambient air is above a predetermined temperature, heating the fluid using the engine when the ambient air is below the predetermined temperature, and transferring heat from the fluid in the internal heat exchanger to the vehicle cargo compartment.

The method may further include circulating the fluid between the engine and the external heat exchanger. Transferring heat from the fluid in the internal heat exchanger to the vehicle cargo compartment may occur when the fluid is below a set point temperature. Circulating the fluid between the internal heat exchanger and the external heat exchanger may occur when the fluid is below a set point temperature. Circulating the fluid may include pumping the fluid under battery power. Transferring heat from the ambient air to the fluid in the external heat exchanger may include moving the external heat exchanger through the ambient air. Transferring heat from the fluid to the vehicle cargo compartment in the internal heat exchanger may include forcing air through the internal heat exchanger.

### BRIEF DESCRIPTION OF DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an HVAC/R system in accordance with an embodiment of the present disclosure; and

FIG. 2 illustrates a method of operating an HVAC/R system in accordance with an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

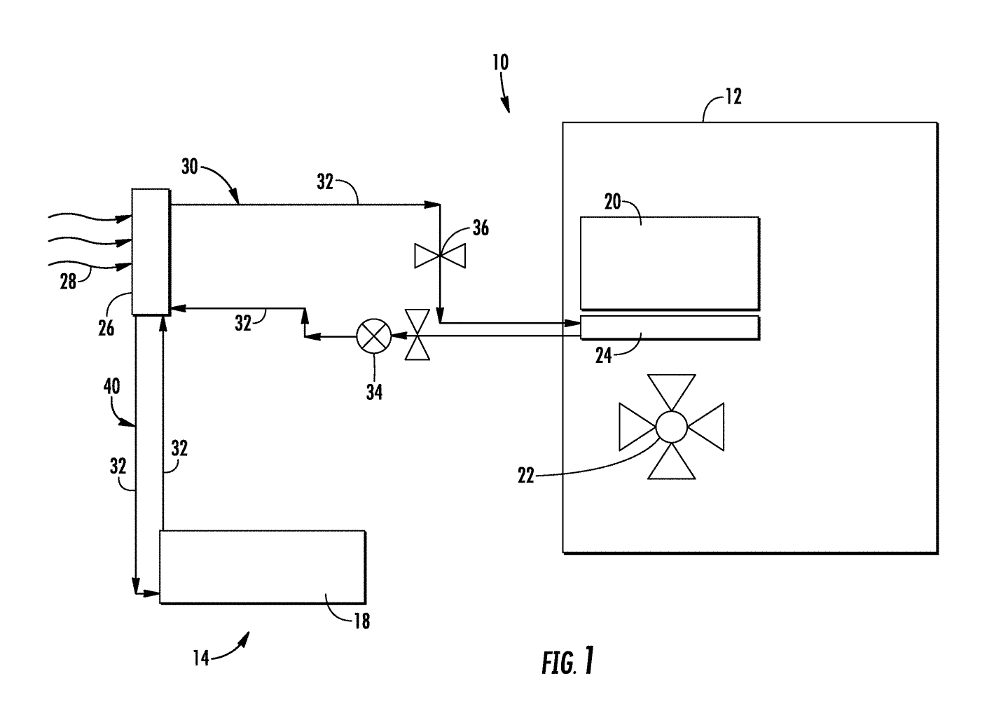

FIG. 1 illustrates a schematic diagram of an embodiment of a heating, ventilation, air conditioning, and refrigeration (HVAC/R) system 10 in an embodiment of the present disclosure. In an embodiment, the HVAC/R system 10 is provided for a vehicle cargo compartment 12. In an embodiment, the vehicle cargo compartment 12 is a trailer or other portion of a vehicle 14 that may be heated or cooled. The vehicle 14 includes an engine or motor (not shown), such as an internal combustion engine in a non-limiting example, to provide motive power for the vehicle 14. The vehicle 14 in another embodiment includes a transport refrigeration unit (TRU) that includes a TRU engine 18. The HVAC/R system 10 forms part of the TRU in an embodiment.

The HVAC/R system 10 of an embodiment includes an evaporator 20 in fluid communication with or disposed at least partially inside the vehicle cargo compartment 12. The HVAC/R system 10 of an embodiment further includes an internal heat exchanger 24 in fluid communication with or disposed at least partially inside the vehicle cargo compartment 12. The HVAC/R system 10 of an embodiment further includes a fan 22 or other device capable of forcing air over or through the evaporator 20 and/or the internal heat exchanger 24. In an embodiment, the evaporator 20 is adjacent and/or coupled to the internal heat exchanger 24 such that the fan 22 forces air in the vehicle cargo compartment 12 over both the internal heat exchanger 24 and the evaporator 20.

The system 10 includes an external heat exchanger 26 disposed outside of the vehicle cargo compartment 12 or another location in fluid communication with ambient air 28. The external heat exchanger 26 of an embodiment is mounted at a front portion of the vehicle cargo compartment 12 for exposure to the ambient air 28 over its surface area.

The external heat exchanger 26 is configured to transfer heat from ram air, or the ambient air 28 being forced along, against, or through the external heat exchanger 26, to a fluid 32 when the vehicle cargo compartment 12 is moving. Therefore, heat from the ambient air 28 is added to the fluid 32 in the external heat exchanger 26 in one embodiment by moving the external heat exchanger 26 through the ambient air 28. When the vehicle cargo compartment 12 is stationary, the external heat exchanger 26 is configured to transfer heat from the ambient air 28 to the fluid 32, such as by natural convection in a non-limiting example.

A fluid circuit 30 circulates the fluid 32 between the external heat exchanger 26 and the internal heat exchanger 24. The fluid 32 is a liquid engine coolant in one non-limiting example. The fluid 32 may be any fluid capable of transferring heat from or to a heat exchanger in additional embodiments. A pump 34 circulates the fluid 32 within the fluid circuit 30 in an embodiment. The pump 34 of one embodiment operates under battery power to circulate the fluid 32 without the aid of the vehicle engine or TRU engine 18. One or more valves 36 allow or restrict circulation of the fluid 32 through the fluid circuit 30. A controller (not shown) controls operation of the system 10, including the pump 34 and the valves 36, according to one or more algorithms, sensed values, stored values, and/or local or remote command inputs as recognized by those having ordinary skill in the art. The controller may selectively operate the pump 34 and/or one or more of the valves 36 through one or more output signals from the controller according to one or more set points of the system 10.

In a non-limiting embodiment, the air temperature in the vehicle cargo compartment 12 may be below a desired set point of the system 10, the system 10 may require a defrost operation to remove frost from the evaporator 20, or another condition may exist that requires heat to be added to the fluid 32 and/or the vehicle cargo compartment 12. When the temperature of the ambient air 28 is above a predetermined temperature, such as above 32 degrees Fahrenheit or 0 degrees Celsius in one non-limiting example, the engine 18 is controlled to be shut down or not operational, and the pump 34 circulates the fluid 32 via battery power through the fluid circuit 30 to allow the ambient air 28 to add heat to the fluid 32 at the external heat exchanger 26. The fluid 32 continues to circulate as the internal heat exchanger 24 allows transfer of the heat from the fluid 32 to the vehicle cargo compartment 12 to defrost the evaporator 20 and/or raise the temperature of the air in the vehicle cargo compartment 12, such as to the desired set point of the system 10.

The system 10 further includes a second fluid circuit 40 configured to selectively circulate the fluid 32 between the external heat exchanger 26 and the engine 18. In one embodiment, the engine 18 transfers heat to the fluid 32. In an embodiment not shown, the second fluid circuit 40 circulates fluid 32 between the external heat exchanger 26 and the vehicle engine or another heat source. When the ambient air 28 is below the predetermined temperature, normal operation of the TRU engine 18 commences. During such operation in one embodiment, the second fluid circuit 40 is configured to circulate the fluid 32 between the external heat exchanger 26 and the engine 18. In an operation of another embodiment, the TRU engine 18 is powered to provide power to one or more heating elements of the external heat exchanger 26 (not shown) or provide heated gas or other fluid from a compressor or other source to the external heat exchanger 26.

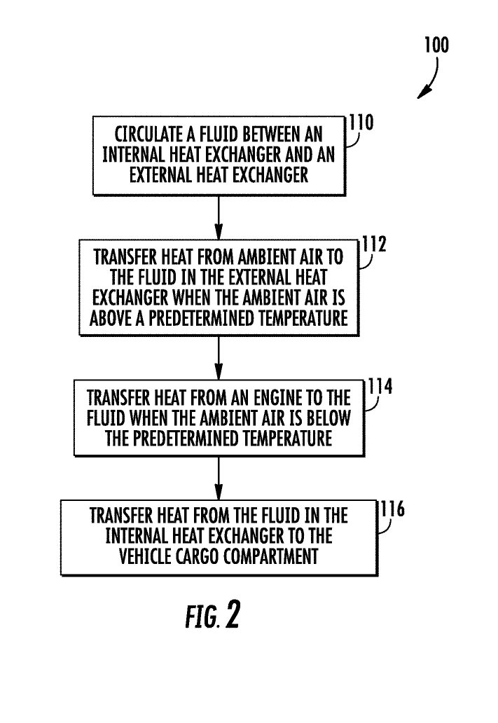

Referring now to FIG. 2, a method 100 of operating the HVAC/R system 10 is provided. The method 100 includes circulating, at step 110, the fluid 32 between the internal heat exchanger 24 and the external heat exchanger 26. As in the non-limiting embodiment discussed above, the air temperature in the vehicle cargo compartment 12 may be below a desired set point of the system 10, the system 10 may require a defrost operation to remove frost from the evaporator 20, and/or another condition may exist that requires heat to be added to the fluid 32 and/or the vehicle cargo compartment 12. Following the discussion above, the method 100 further includes transferring, at step 112, heat from the ambient air 28 to the fluid 32 in the external heat exchanger 26 when the ambient air 28 is above the predetermined temperature.

The method 100 further includes transferring, at step 114, heat from the engine 18 to the fluid 32 when the ambient air 28 is below the predetermined temperature. When the temperature of the ambient air 28 is below the predetermined temperature, such as below 32 degrees Fahrenheit or 0 degrees Celsius in a non-limiting example, the engine 18 operates normally to circulate the fluid 32 through the fluid circuit 30 and the second fluid circuit 40 and to add heat from the engine 18 to the fluid 32. The method 100 further includes transferring, at step 116, heat from the fluid 32 in the internal heat exchanger 24 to the vehicle cargo compartment 12. The fluid 32 continues to circulate as the internal heat exchanger 24 allows transfer of the heat from the fluid 32 to the vehicle cargo compartment 12 to defrost the evaporator 20 and/or raise the temperature of the air in the vehicle cargo compartment 12, such as to the desired set point of the system 10. The predetermined temperature is between 25 and 40 degrees Fahrenheit in one embodiment, and between 30 and 35 degrees Fahrenheit in another embodiment.

The system 10 and method 100 disclosed herein raises the temperature in the vehicle cargo compartment 12, such as to reach a desired set point temperature or defrost the evaporator 20. Rather than starting and running the engine 18 whenever even a small amount of heat is required, ambient air 28 above the predetermined temperature is utilized to accomplish the goal of increasing the air temperature in the vehicle cargo compartment 12. The system 10 and method 100 described herein more efficiently and effectively raises the air temperature in the vehicle cargo compartment 12 without unnecessary consumption of fuel by or wear on the engine 18 and/or contributing to air and noise pollution otherwise caused by the engine 18.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. An HVAC/R system for a vehicle cargo compartment, the HVAC/R system comprising:
an external heat exchanger disposed outside of the vehicle cargo compartment and configured to transfer heat from ambient air to a fluid;
an internal heat exchanger disposed inside of the vehicle cargo compartment and configured to transfer heat from the fluid to the vehicle cargo compartment; and
a fluid circuit configured to selectively circulate the fluid between the external heat exchanger and the internal heat exchanger.

2. The system of claim 1, wherein the external heat exchanger is configured to transfer heat from ram air to the fluid when the vehicle cargo compartment is moving.

3. The system of claim 1, wherein the external heat exchanger is configured to transfer heat from ambient air to the fluid when the vehicle cargo compartment is stationary.

4. The system of claim 1, further comprising an evaporator heat exchanger and an evaporator fan disposed inside of the vehicle cargo compartment, the internal heat exchanger transferring heat from the fluid to the vehicle cargo compartment with the evaporator fan.

5. The system of claim 1, wherein the fluid circuit includes a pump configured to selectively circulate the fluid.

6. The system of claim 5, wherein the pump is configured to be operated under battery power.

7. The system of claim 1, further comprising a second fluid circuit configured to selectively circulate the fluid between the external heat exchanger and an engine, the engine transferring heat to the fluid.

8. The system of claim 7, wherein the second fluid circuit is configured to circulate the fluid between the external heat exchanger and the engine when the ambient air is below a predetermined temperature.

9. The system of claim 8, wherein the fluid circuit is in fluid communication with the second fluid circuit when the ambient air is below the predetermined temperature.

10. A method of operating an HVAC/R system in a vehicle cargo compartment, the method comprising:
circulating a fluid between an internal heat exchanger and an external heat exchanger;
transferring heat from ambient air to the fluid in the external heat exchanger when the ambient air is above a predetermined temperature;
heating the fluid using the engine when the ambient air is below the predetermined temperature; and
transferring heat from the fluid in the internal heat exchanger to the vehicle cargo compartment.

11. The method of claim 10, further comprising circulating the fluid between the engine and the external heat exchanger.

12. The method of claim 10, wherein transferring heat from the fluid in the internal heat exchanger to the vehicle cargo compartment occurs when the fluid is below a set point temperature.

13. The method of claim 10, wherein circulating the fluid between the internal heat exchanger and the external heat exchanger occurs when the fluid is below a set point temperature.

14. The method of claim 10, wherein circulating the fluid includes pumping the fluid under battery power.

15. The method of claim 10, wherein transferring heat from the ambient air to the fluid in the external heat exchanger includes moving the external heat exchanger through the ambient air.

16. The method of claim 10, wherein transferring heat from the fluid to the vehicle cargo compartment in the internal heat exchanger includes forcing air through the internal heat exchanger.
